(19) United States
(12) Patent Application Publication
(10) Pub. No.: US 2025/0173831 A1
(43) Pub. Date: May 29, 2025

(54) METHOD, COMPUTER DEVICE, AND NON-TRANSITORY COMPUTER-READABLE RECORDING MEDIUM FOR GENERATING HIGH-QUALITY IMAGE WITH PERSONAL IDENTITY OF PERSON

(71) Applicant: LINE Plus Corporation, Seongnam-si (KR)

(72) Inventors: Sungcheon LEE, Seongnam-si (KR); Hyogun LEE, Seongnam-si (KR); Seungjun LEE, Seongnam-si (KR); Hyukjae JANG, Seongnam-si (KR)

(73) Assignee: LINE Plus Corporation, Seongnam-si (KR)

(21) Appl. No.: 18/945,826

(22) Filed: Nov. 13, 2024

(30) Foreign Application Priority Data
Nov. 23, 2023 (KR) 10-2023-0164902

(51) Int. Cl. G06T 5/50; G06T 3/60; G06T 7/13; G06T 7/62; G06T 7/70; G06T 11/00; G06T 11/60; G06V 10/24

(52) U.S. Cl. CPC G06T 5/50; G06T 3/60; G06T 7/13; G06T 7/62; G06T 7/70; G06T 11/001; G06T 11/60; G06V 10/24; G06T 2207/20221; G06T 2207/30201

(57) ABSTRACT

A method for high-quality image creation that allows for personal identity of a person may include acquiring a merged image by merging a face area of a source image with a body target image; and providing the merged image and an edge image of the merged image as input to an artificial intelligence model for image creation.

### CROSS-REFERENCE TO RELATED APPLICATION(S)

This U.S. non-provisional application and claims the benefit of priority under 35 U.S.C. § 119 to Korean Patent Application No. 10-2023-0164902, filed on Nov. 23, 2023, the entire contents of which are incorporated herein by reference in their entirety.

### BACKGROUND

### Technical Field

Some example embodiments relate to technology for creating a portrait photo through artificial intelligence (AI).

### Related Art

Currently, due to the rapid growth of artificial intelligence and deep learning, new technologies that did not exist in the past are emerging. Among them, a generative model is representative technology.

Various types of generative models are present, such as a generative adversarial network (GAN) and a variational autoencoder (VAE), and such a generative model refers to a model having the ability to learn and create rules within data for data of which probability distribution is difficult to mathematically define, such as an image or an audio.

This artificial intelligence-based generative model may learn an image of a given person and may create various images for the same person.

### SUMMARY

Some example embodiments may create a high-quality image with personal identity of a corresponding person using one frontal face photo.

Some example embodiments may create a portrait photo of quality that meets requirements according to an ID photo standard.

At least some example embodiments relate to an image creation method implemented on a computer device including at least one processor.

In some example embodiments, the image creation method includes merging, by the at least one processor, a face area of a subject within a source image with a body target image to generate a merged image; and providing, by the at least one processor, the merged image and an edge image of the merged image as input to an artificial intelligence model for image creation.

In some example embodiments, the source image is a frontal face photo of the subject to be composited, and the body target image is a frontal photo of an upper body that meets an identification (ID) photo standard.

In some example embodiments, the image creation method includes changing, by the at least one processor, a background color of the body target image, before the merging of the face area with the body target image.

In some example embodiments, the image creation method includes removing, by the at least one processor, a hair part below ears of the subject in the source image based on a parsing result of the source image, before the merging of the face area with the body target image.

In some example embodiments, the merging includes rotating the source image in consideration of a face direction of the subject through face align; and aligning and merging the face area of the subject in the source image with a face area of the body target image.

In some example embodiments, the merging includes determining a size of the face area aligned in the body target image by determining a scale factor for the face area using at least one of a face width and a face height of the body target image.

In some example embodiments, the image creation method includes determining the scale factor for the face area using both the face width and the face height of the body target image, wherein a greater weight is assigned to the face height than the face width.

In some example embodiments, the merging includes determining a size of the face area aligned in the body target image using an intermediate value between a face width and a face height of the body target image and a ratio between the face width and a shoulder width of the body target image.

In some example embodiments, the merging includes determining a position of the face area aligned in the body target image based on a chin position of the body target image.

In some example embodiments, the merging includes determining a position of the face area aligned in the body target image based on a neck length determined based on a distance between a chin position of the body target image and a line connecting both shoulders.

In some example embodiments, the merging includes creating the edge image through edge detection for the merged image; and removing an edge of a neck part based on a jawline in the edge image.

In some example embodiments, the merging includes creating the edge image through edge detection for the merged image; extracting a jawline from the face area based on a parsing result of the face area; and adding the jawline extracted from the face area to the edge image.

In some example embodiments, the merging includes creating the edge image through edge detection for the merged image while preserving an original ear shape of the face area by adjusting a threshold for the edge detection and a control weight for a degree of freedom of image creation.

In some example embodiments, the providing includes separating the edge image into a face edge image that includes an edge of a face part and a non-face edge image that includes a remaining edge excluding the face part.

In some example embodiments, the image creation method includes creating, by the at least one processor, a portrait photo using the merged image and the edge image through the artificial intelligence model, wherein a control weight for limiting a degree of freedom of image creation is set to the face edge image.

In some example embodiments, the image creation method includes creating, by the at least one processor, a portrait photo using the merged image and the edge image through the artificial intelligence model; and modulating a hairstyle of the portrait photo using a hair mask.

In some example embodiments, the modulating includes modulating the hairstyle of the portrait photo using the hair mask with an area expanded toward an outer background of face of the body target image as a mask with an area larger than a hair part of the body target image.

In some example embodiments, the modulating includes modulating the hairstyle of the portrait photo using a fake hairstyle shape that is a composite of a head part of the body target image and a shape with a set area based on the head part.

Some example embodiments relate to a non-transitory computer-readable recording medium storing instructions that, when executed by a processor, cause the processor to perform the image creation method on the computer device.

Some example embodiments relate to a computer device including at least one processor configured to execute computer-readable instructions on the computer device to cause the computer device to, merge a face area of a subject within a source image with a body target image to generate a merged image, and provide the merged image and an edge image of the merged image as input to an artificial intelligence model for image creation.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to at least one example embodiment;

FIG. 2 is a diagram illustrating an example of a computer device according to at least one example embodiment;

FIG. 3 is a flowchart illustrating an example of a method performed by a computer device according to at least one example embodiment;

FIG. 4 illustrates an example of a face image and a body image according to at least one example embodiment;

FIGS. 5 to 8 illustrate examples of describing an image preprocessing process according to at least one example embodiment;

FIGS. 9 and 10 illustrate examples of describing an image alignment and merging process according to at least one example embodiment;

FIG. 11 illustrates an example of describing a process of determining a face size according to at least one example embodiment;

FIGS. 12 to 14 illustrate examples of describing an edge image acquisition process according to at least one example embodiment;

FIGS. 15 and 16 illustrate examples of describing an image creation process according to at least one example embodiment; and

FIGS. 17 to 20 illustrate examples of describing a hair modulation process according to at least one example embodiment.

### DETAILED DESCRIPTION

One or more example embodiments will be described in detail with reference to the accompanying drawings. Example embodiments, however, may be embodied in various different forms, and should not be construed as being limited to only the illustrated example embodiments. Rather, the illustrated example embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, some example embodiments will be described with reference to the accompanying drawings.

Some example embodiments relate to technology for creating a portrait photo through artificial intelligence (AI).

At least some example embodiments are directed to a method, device, system and non-transitory computer-readable recording medium that creates a portrait photo with personal identity of quality that meets requirements according to an ID photo standard using one frontal face photo.

An image creation system according to some example embodiments may be implemented by at least one computer device. An image creation method according to some example embodiments may be performed by at least one computer device included in the image creation system. Here, a computer program according to some example embodiments may be installed and run on the computer device and the computer device may perform the image creation method according to example embodiments under control of the computer program. The aforementioned computer program may be stored in a non-transitory computer-readable recording medium to implement the image creation method in conjunction with the computer device.

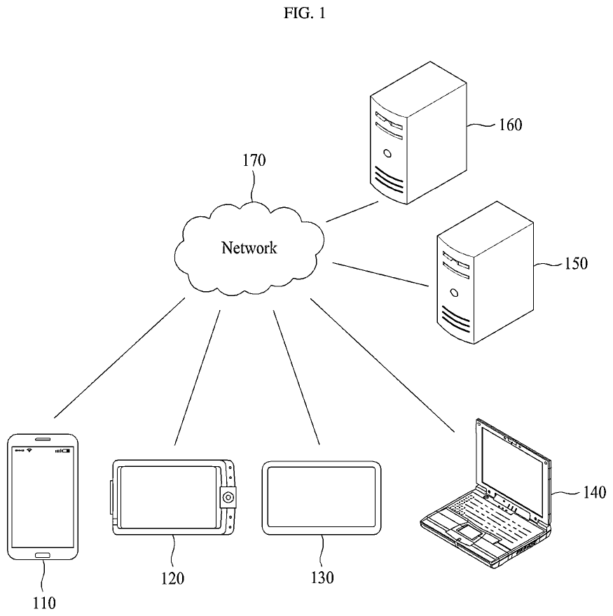

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. The number of electronic devices or the number of servers is not limited thereto. Also, the network environment of FIG. 1 is provided as one example of environments applicable to the example embodiments and an environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited and may include other schemes such as a near field wireless communication scheme between devices as well as a communication scheme using a communication network (e.g., a mobile communication network, wired Internet, wireless Internet, and a broadcasting network) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, these topologies are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service, for example, an image creation service, to the plurality of electronic devices 110, 120, 130, and 140 connected over the network 170.

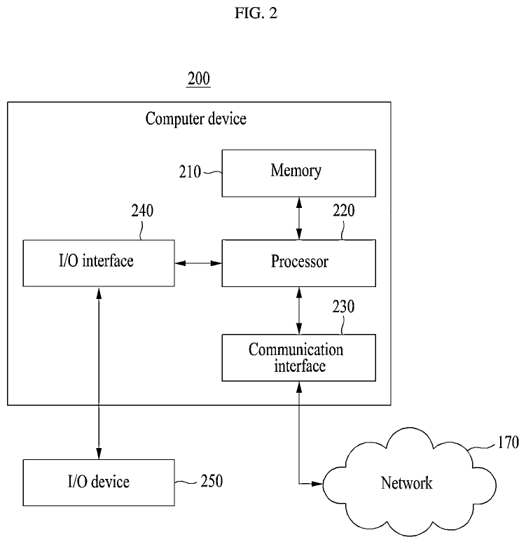

FIG. 2 is a block diagram illustrating an example of a computer device according to at least one example embodiment. Each of the plurality of electronic devices 110, 120, 130, and 140 or each of the servers 150 and 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable recording medium. The permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable recording medium separate from the memory 210. The other non-transitory computer-readable recording medium may include a non-transitory computer-readable recording medium, for example, a floppy drive, a disk, a tape, a DVD/CD-ROM drive, a memory card, etc. According to other example embodiments, software components may be loaded to the memory 210 through the communication interface 230, instead of the non-transitory computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided by the memory 210 or the communication interface 230 to the processor 220. For example, the processor 220 may be configured to execute received instructions in response to a program code stored in a storage device, such as the memory 210.

The communication interface 230 may provide a function for communication between the communication device 200 and another apparatus, for example, the aforementioned storage devices. For example, the processor 220 of the computer device 200 may forward a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200. For example, a signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

Also, according to other example embodiments, the computer device 200 may include a greater or smaller number of components than the number of components of FIG. 2. However, there is no need to clearly illustrate most conventional components. For example, the computer device 200 may be configured to include at least a portion of the I/O device 250 or may further include other components, such as a transceiver and a database.

Hereinafter, example embodiments of a method and device for creating a high-quality image that provides sufficient personal identify of a person are described in detail.

Currently, an artificial intelligence-based generative model may create a photo of a person specified as a prompt while being close to data used for learning through learning using several portrait photos. However, some results using the generative model may have the very degraded quality and may also be created with a completely different feeling from the specified person.

Given a source photo of a person, artificial intelligence may automatically create a photo similar to the person through a complex model with a large number of parameters, which often involves a black box problem without transparency. In artificial intelligence, tens of millions of neural networks form a complex hidden layer structure and it may be impossible to accurately understand or track numerous relationships and connections within a learning neural network. That is, the black box refers to a state in which there is no readily apparent explanation for a creation process or method of results produced by artificial intelligence.

Example embodiments may include image processing technology that reflects requirements for a photo standard and personal identity using an image created through artificial intelligence. Through a stepwise procedure using various artificial intelligence models, it is possible to create a more realistic, natural, and high-quality portrait photo with personal identity that bears a very similar resemblance to an original subject associated with the portrait.

The computer device 200 according to example embodiments may provide a client with an image creation service through connection to an exclusive application installed on the client or a website/mobile site related to the computer device 200. An image creation system implemented as a computer may be configured in the computer device 200. For example, the image creation system may be implemented in a form of a program that independently operates or may be configured in an in-app form of a specific application, for example, a messenger, to be operable on the specific application.

The processor 220 of the computer device 200 may be implemented as a component for performing the following image creation method. Depending on example embodiments, components of the processor 220 may be selectively included in or excluded from the processor 220. Also, depending on example embodiments, the components of the processor 220 may be separated or merged for functional representation of the processor 220.

The processor 220 and the components of the processor 220 may control the computer device 200 to perform operations included in the following image creation method. For example, the processor 220 and the components of the processor 220 may be configured to execute an instruction according to a code of at least one program and a code of an OS included in the memory 210.

Here, the components of the processor 220 may be representations of different functions performed by the processor 220 in response to an instruction provided from a program code stored in the computer device 200.

The processor 220 may read an instruction from the memory 210 to which instructions related to control of the computer device 200 are loaded. In this case, the read instruction may include an instruction for controlling the processor 220 to perform the following operations.

The following operations included in the image creation method may be performed in an order different from illustrated order. A portion of the operations may be omitted or an additional process may be further included.

Operations included in the image creation method may be performed by the server 150, and at least a portion of the operations may also be performed by the client depending on example embodiments.

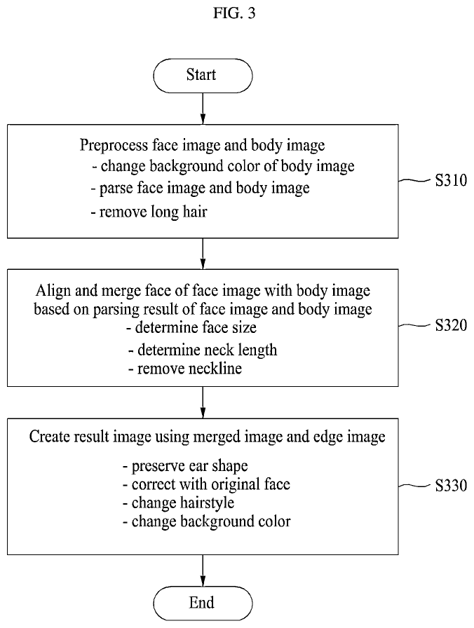

FIG. 3 is a flowchart illustrating an example of a method performed by a computer device according to at least one example embodiment.

Referring to FIG. 3, in operation S310, the processor 220 may preprocess a given face image and body image. Here, the face image may refer to a source image given by a user and the body image may refer to a target image given by the user or specified by default. The example embodiments aim to create an ID photo that is very similar to the original face of the face image using the face image and the body image. The processor 220 may perform a preprocessing process to minimize noise in an image. Here, the preprocessing process may include a process of changing a background color of the body image, a process of parsing the face image and the body image, and/or a process of removing a long hair part from the face image. Details of the image preprocessing process are described again below.

In operation S320, the processor 220 may align and merge the original face with the body image. In other words, the processor 220 may align and merge a face area of the face image with a face area of the body image based on a parsing result of the face image and the body image. The processor 220 may rotate the original face and align the same at an appropriate position through vision technology such as face align. Here, the processor 220 may remove the face from the body image and then copy the face of the face image and may paste the copied face into the body image from which the face is removed. Then, the processor 220 may acquire an edge image from the merged image in which the original face is pasted into the body image. For example, the processor 220 may detect the edge of the merged image through vision technology such as a canny edge detector. In particular, the processor 220 may perform a process of determining a size of the original face to be pasted into the body image, a process of determining a neck length that serves as a position of the original face, and a process of removing a neckline as an additional preprocessing process to create a high-quality image. Details of the image processing process are described again below.

In operation S330, the processor 220 may perform image creation using the merged image in which the original face of the face image is merged with the body image and the edge image of the merged image. The merged image may serve as the source image for image creation and the edge image may serve to provide a shape to be preserved in the image creation process. In the example embodiment, the merged image and the edge image may be input to the artificial intelligence-based generative model. Here, img2img ControlNet, such as stable diffusion, may be used as the artificial intelligence model for image creation. Here, the processor 220 may perform the image processing process of preserving an ear shape of the original face by controlling the edge image to create the high-quality image. The original ear shape may be preserved to ensure personal identity that is very similar to the original face. Details of the ear shape preservation process are described again below.

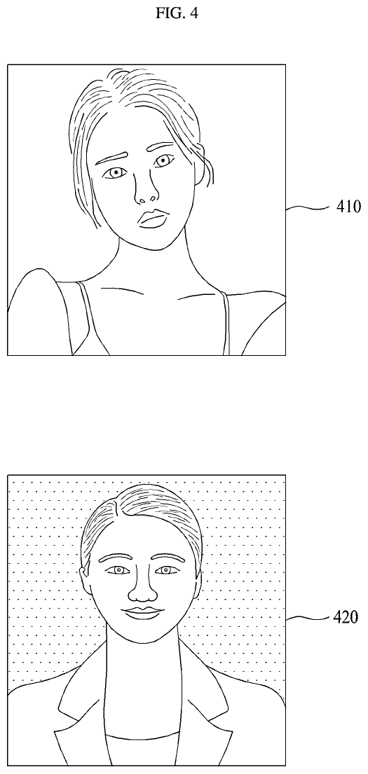

FIG. 4 illustrates an example of a face image and a body image according to at least one example embodiment.

Referring to FIG. 4, a face image 410 may refer to a frontal face photo of a person to be composited and a body image 420 may refer to a photo of the upper body that serves as a base when being composited with the face image 410. The body image 420 may be an image that follows an ID photo standard, such as an image that includes a neck and shoulders. Although not included in a composite result, it may be desirable for the body image 420 to be a frontal photo that also includes a face to determine a proportion and a position during compositing.

ID photo standard requirements may refer to the specifications for photos used for official documents or identification cards, such as passports, driver's licenses, and student IDs. In some example embodiments, the computer device 200 may ascertain the ID photo standard requirements by extracting the ID photo standard requirements from, for example, an online database such as a database associated with a governmental or other agency, and may provide the extracted ID photo standard requirements to the AI artificial intelligence model. For example, the specifications may include the size and ratio of the photo, the background color, as well as requirements that the subject's face must appear in the full frame of the photo with the ears of the subject having to be visible. However, example embodiments are not limited thereto. The AI artificial intelligence model may utilize these ID photo standard requirements when performing the image creation.

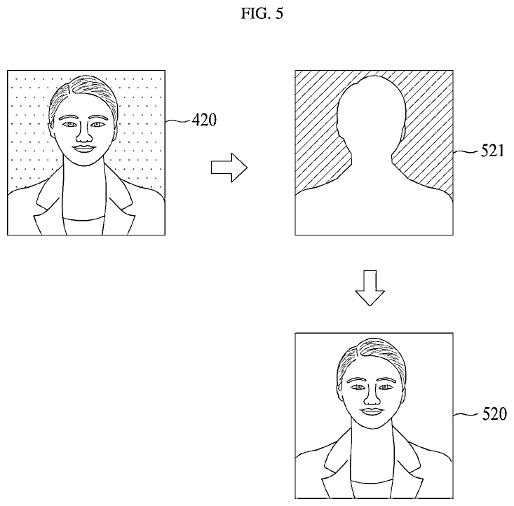

FIGS. 5 to 8 illustrate examples of describing an image preprocessing process according to at least one example embodiment.

Initially, the processor 220 may change a background color of the body image 420. Referring to FIG. 5, the processor 220 may change the background color of the body image 420 using a background body image mask 521 created from the body image 420 and may acquire a body image 520 with the changed background color. Changing the background color of the body image 420 is to inhibit (or, alternatively, prevent) some pixels from remaining in a part, such as hair, during a compositing process and degrading the quality of a resulting product.

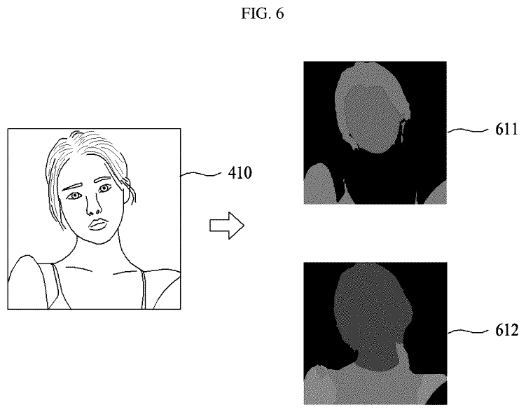

The processor 220 may parse the face image 410 and the body image 520 with the background color changed, for each part. Here, for parsing, the processor 220 may use a deep learning-based segmentation model, such as a linear integer programming (LIP) model and a Programming Language named for Blaise Pascal (PASCAL) model. For example, referring to FIG. 6, a parts analysis result 611 may be acquired by parsing hair, face, and upper body from the face image 410 using the LIP model, and a parts analysis result 612 may be acquired by parsing head, both arms, and bust from the face image 410 using the PASCAL model.

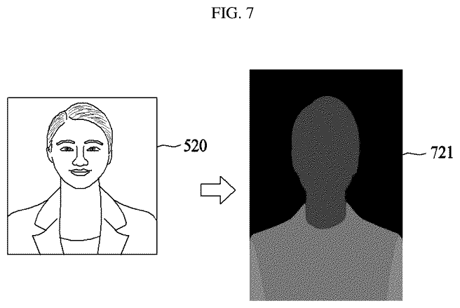

Referring to FIG. 7, in the case of the body image 520, parts analysis may be performed using the PASCAL model. The parts analysis results 611 and 612 of the face image 410 and a parts analysis result 721 of the body image 520 may be used in the following image processing process or image creation process.

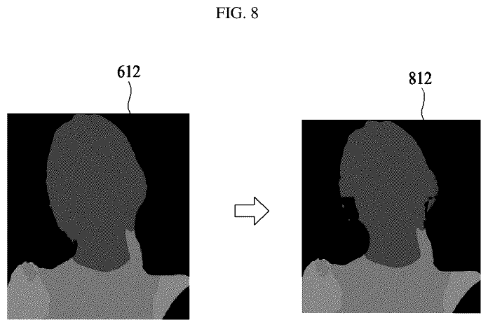

Here, the processor 220 performs a task of editing a hair part to create a relationship between a head shape and a body. Referring to FIG. 8, the processor 220 removes all hair below the ears based on the ears in the parts analysis result 612 by the PASCAL model between the parts analysis results 611 and 612 of the face image 410. The processor 220 may compare the parts analysis result 611 by the LIP model and the parts analysis result 612 by the PASCAL model of the face image 410 and may crop a long hair and a neck part from the parts analysis result 612 by the PASCAL model and then add the neck. When adding the neck, a morphology opening operation may be used to remove noise caused by discrepancy between the parts analysis result 611 by the LIP model and the parts analysis result 612 by the PASCAL model. In the case of a photo in which the hair touches a shoulder line, the processor 220 removes all the hair part below the ears during a preprocessing process to solve the problem of mistaking the hair for a shape such as a collar. In the following, when using a parts analysis result by the PASCAL model for the face image 410, a parts analysis result 812 in which the long hair is removed may be used instead of the initial parts analysis result 612.

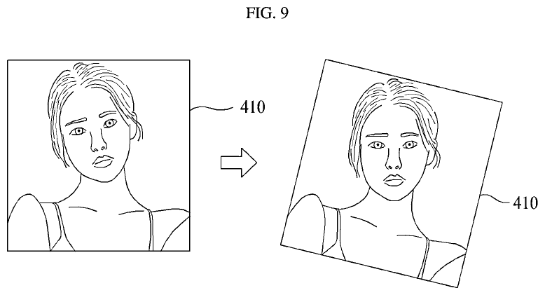

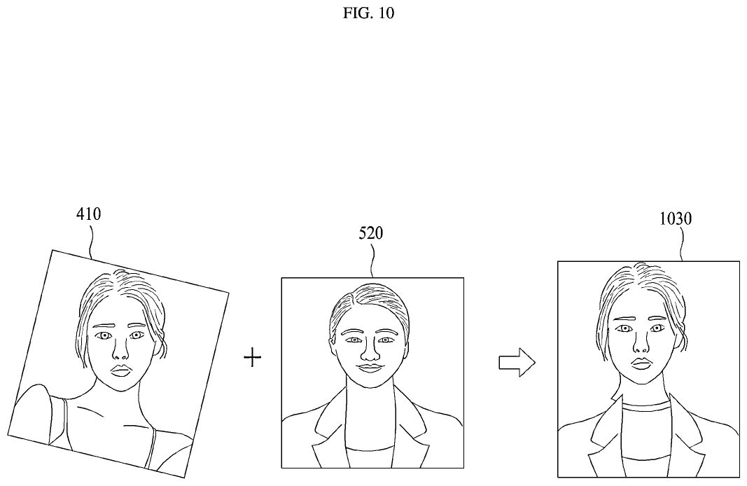

FIGS. 9 and 10 illustrate examples of describing an image alignment and merging process according to at least one example embodiment.

Referring to FIG. 9, the processor 220 may vertically rotate a face direction of the face image 410 to perform a face align. That is, the processor 220 may rotate the face image 410 such that the head of the original face within the face image 410 is in a straightly vertical direction without tilting.

Referring to FIG. 10, the processor 220 may acquire a merged image 1030 by removing the head part including the face from the body image 520 and then copying the head part of the face image 410 rotated in consideration of the face direction, and pasting the same into the body image 520 from which the head part is removed. Here, in an image merging process, the head part in which the hair part below the ears is removed from the face image 410 may be merged with the body image 520.

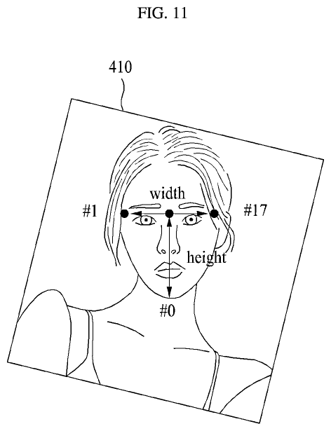

FIG. 11 illustrates an example of describing a process of determining a face size according to at least one example embodiment.

In a resulting image of an artificial intelligence-based generative model, a head size of the generated image may be affected by a head size of an input image. In the image merging process, if a proportion between the face image 410 and the body image 520 does not match, the artificial intelligence model tends to ignore the face and to create a different structure instead of adjusting the face. As such, since a difference in face size between images may affect the image quality, it may be desirable to control the face size.

The processor 220 may create the merged image 1030 by applying a facial proportion method between the face image 410 and the body image 520. For example, the processor 220 may apply a method of matching the face size between the face image 410 and the body image 520 on a one-to-one basis. As another example, the processor 110 may determine the face size by computing a scale factor for a size of the original face of the face image 410 to be merged compared to the face size in the body image 520. Here, the processor 220 may compute the scale factor using at least one of a face width and a face height. Referring to FIG. 11, the processor 220 may compute the scale factor through Equation 1, using a distance from a leftmost point (#1) of the face to a rightmost point (#17) of the face among face landmarks as the face width.

Scale factor=(face_width_from_body_image=face_width_from_face_image−1.0)×scale_weight+1.0 [Equation 1]

Also, the processor 220 may compute the scale factor through Equation 2 using a length of line that connects an end point of chin (#0) at an intermediate position between the leftmost point (#1) of the face and the rightmost point (#17) of the face (i.e., between eyebrows) as the face height.

Scale factor=(face_height_from_body_image=face_height_from_face_image−1.0)xscale_weight+1.0 [Equation 2]

Also, the processor 220 may also compute the scale factor using a combination of a method that uses the face width and a method that uses the face height, as shown in Equation 3 below. When determining the face size using both the face width and the face height, a greater weight may be applied to the face height that is vertical information than the face width that is horizontal information.

scale_by_width=face_width_from_body_image:face_width_from_face_image scale_by_height=face_height_from_body_image=face_height_from_face_image Scale factor=1.0+(((scale_by_width−1.0)+(scale_by_height−1.0))=2)xscale_weight) [Equation 3]

In addition to the aforementioned scale factor computation method, the processor 220 may determine the face size using an intermediate value between the face width and the face height or may determine the face size using a ratio between the face width and the shoulder width depending on example embodiments.

In the image merging process, in addition to the face size, the neck length that determines a face position may also affect a subsequent process.

For example, the processor 220 may adjust a position of the original face to be pasted into the body image 520 based on a chin position in the body image 520. As another example, the processor 220 may adjust the neck length at a desired (or, alternatively, a predetermined) ratio compared to the face height of the face image 410. Here, the processor 220 may determine the face position by computing a distance between a lowest point (#0) indicating the chin position among face landmarks and a center point of a line that connects both shoulders as the neck length. Through a method of combining the aforementioned two methods with different weights, the processor 220 may also determine a position of the original face to be pasted into the body image 520. Depending on example embodiments, a manual method may be supported, such as a method of providing image examples with different neck lengths to the user corresponding to a service recipient to select a desired image or a method of providing a calibration tool such that the user may directly adjust the neck length.

The processor 220 may acquire the merged image 1030 with an appropriate body-to-face proportion by determining the face size and position that affect the image quality and then merging the original face using the determined face size and position.

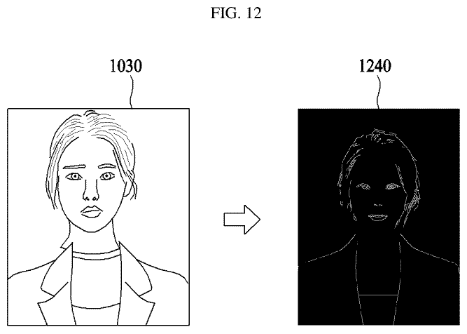

FIGS. 12 to 14 illustrate examples of describing an edge image acquisition process according to at least one example embodiment.

Referring to FIG. 12, the processor 220 may create an edge image 1240 through edge detection for the merged image 1030.

In the case of compositing the original face of the face image 410 by pasting the same into the body image 520, if a neck thickness between the face image 410 that is a source and the body image 520 that is a target is different, an awkward result may be created due to a mismatching proportion between the neck of the source and the body of the target. To solve this problem and to achieve the natural improvement effect of neckline, example embodiments may erase an edge of a neck part from the edge image 1240 and may provide the edge image 1240 from which the neckline is removed as input to an artificial intelligence model (e.g., img2img ControlNet) for image creation.

To find and remove the edge of the neck, the processor 220 may determine the outline of the jaw and estimate a position of the neck. For example, the processor 220 may form a set of line segments by extracting chin landmarks within the range capable of covering the neckline based on the parts analysis result 611 by the LIP model for the face image 410 and then linearly connecting the extracted chin landmarks. Here, the processor 220 may remove the neckline by removing the lower source edge with a margin of some pixels at each point of the line segment that represents the jawline. As shown in FIG. 12, the processor 220 may acquire the edge image 1240 in a form in which the neckline is removed.

In the process of acquiring the edge image 1240 from the merged image 1030, some weak lines, such as jawline, may be removed according to edge detection intensity and a resulting product with a different feeling from the original person may be created. To solve this problem, example embodiments may utilize an image processing process of adding the jawline.

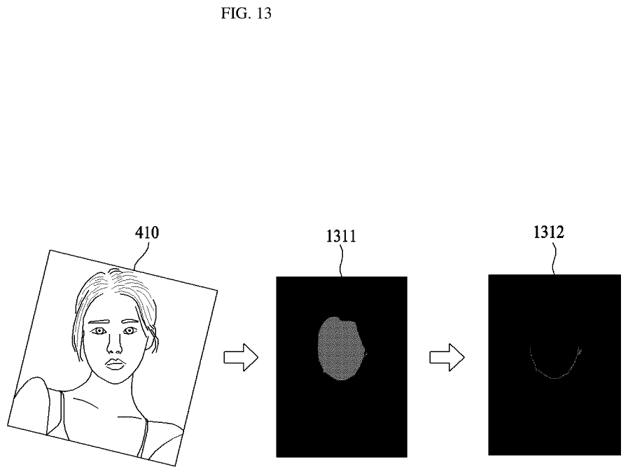

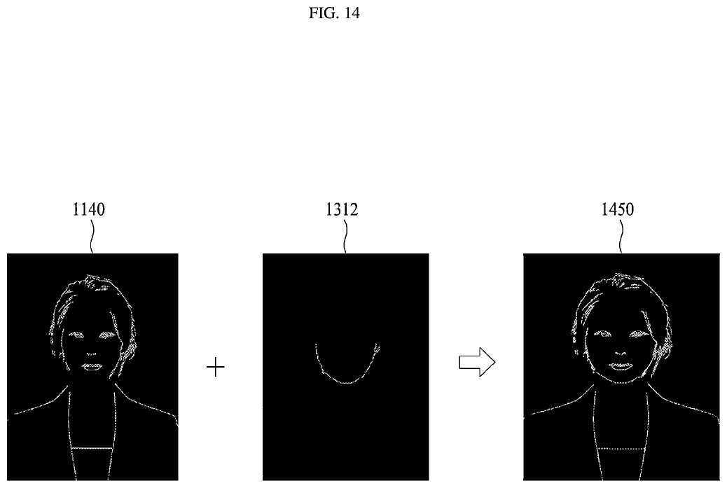

Referring to FIG. 13, the processor 220 may retrieve a face part 1311 from the face image 410 by parsing the face image 410 aligned in the body image 520 for image merging using the LIP model. Here, the jawline 1312 may be extracted from the face part 1311. Then, referring to FIG. 14, the processor 220 may acquire a final edge image 1450 by adding the jawline 1312 extracted from the face part 1311 to the edge image 1240.

The processor 220 may provide the edge image 1450 with the neckline removed and the jawline 1312 added with the merged image 1030 as input to the artificial intelligence model (img2img ControlNet) for image creation.

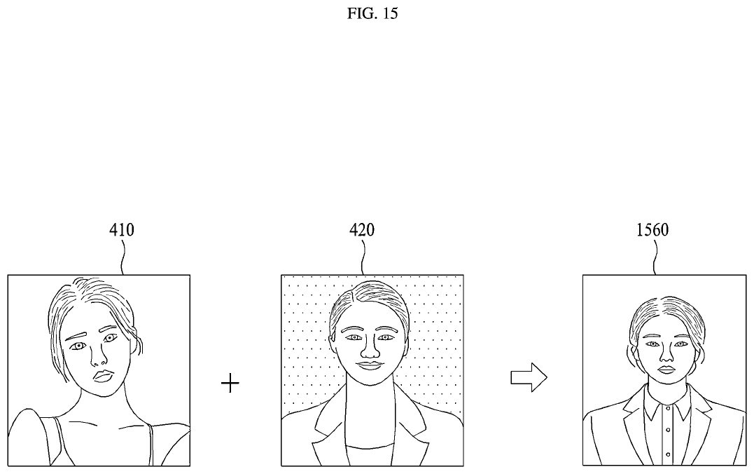

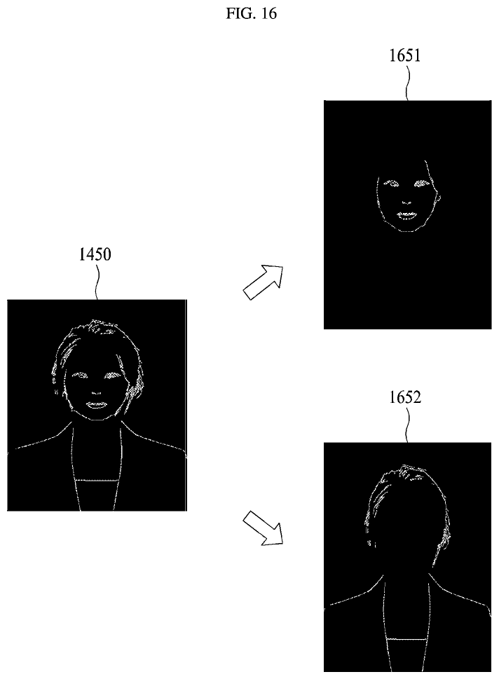

FIGS. 15 and 16 illustrate examples of describing an image creation process according to at least one example embodiment.

Referring to FIG. 15, the processor 220 may create a random photo 1560 similar to the original face using img2img ControlNet for the given face image 410 and body image 420. Here, the merged image 1030 and the edge image 1450 acquired through preprocessing and various types of image processing for the face image 410 and the body image 420 may be input to img2img ControlNet. The processor 220 may create a random photo while preserving the original face using img2img ControlNet and then may perform face swap for a created image.

Example embodiments may use the edge image 1450 as input to the artificial intelligence model with the merged image 1030 for image creation. To further improve the image quality, a face edge image 1651 that includes only an edge of a face part and a non-face edge image 1652 that includes a remaining edge excluding the face part may be separately used as shown in FIG. 16. The face edge image 1651 may be simply produced through the LIP model and a morphology dilation operation may be applied to the non-face edge image 1652 to dilate a face mask (LIP model). That is, unnecessary confusion may be reduced by making a boundary between the face part and the remaining part clearly distinct. The random photo 1560 may be created by preserving the feeling of the original face for the face part while giving a creative freedom for the remaining part other than the face. Here, a control weight of img2img ControlNet for the face edge image 1651 may be set to a level that reduces (or, alternatively, minimizes) the degree of freedom and a control weight for the non-face edge image 1652 may be set to a level that increases (or, alternatively, maximizes) the degree of freedom.

Depending on example embodiments, without using the edge image 1450 as input to the artificial intelligence model, it is possible to input a mask that defines a category created by the artificial intelligence model based on the edge image 1450.

Further, it may be desirable to preserve the ear shape of the original face as much as possible to ensure personal identity of a corresponding person with a feeling as similar as possible to the original face. In the process of acquiring the edge image 1450, vision technology such as a canny edge detector is used. Here, the original ear shape may be preserved by adjusting a threshold for edge detection and a control weight for degree of freedom that defines an image creation category. The threshold of the edge detector at which the original ear shape is preserved and the control weight of img2img ControlNet may be determined by experimental values. For example, the control weight of img2img ControlNet for the face edge image 1651 may be set to 0.3, and the weight control for the non-face edge image 1652 may be set to a value of 1 to 1.2. However, example embodiments are not limited thereto. The edge detection threshold for preserving the ear shape may be set to a lower limit (low) of 70 and an upper limit (high) of 200. Setting the edge detection threshold may be applied not only to preserve the ear shape but also as a measure to solve the problem that the weak jawline is not extracted.

When performing face swap in the random photo 1560 created through img2img ControlNet, the processor 220 may replace only the face in the random photo 1560 with the original face using the face image 410 as a source and using the random photo 1560 as a target.

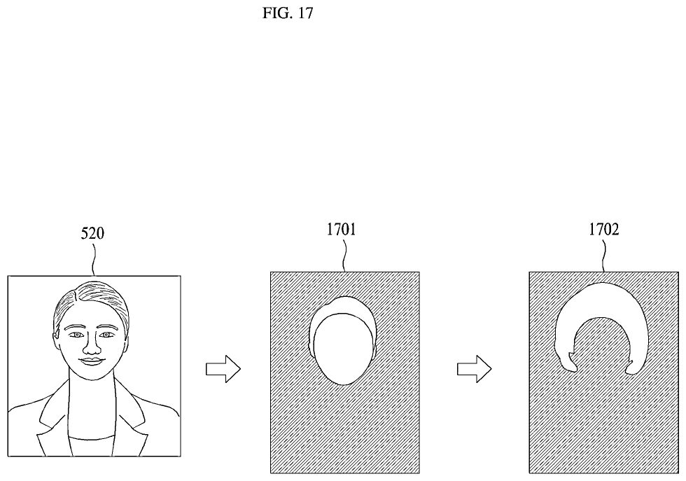

FIGS. 17 to 20 illustrate examples of describing a hair modulation process according to at least one example embodiment.

Example embodiments may modulate a hairstyle within the range that does not damage personal identity such as facial features.

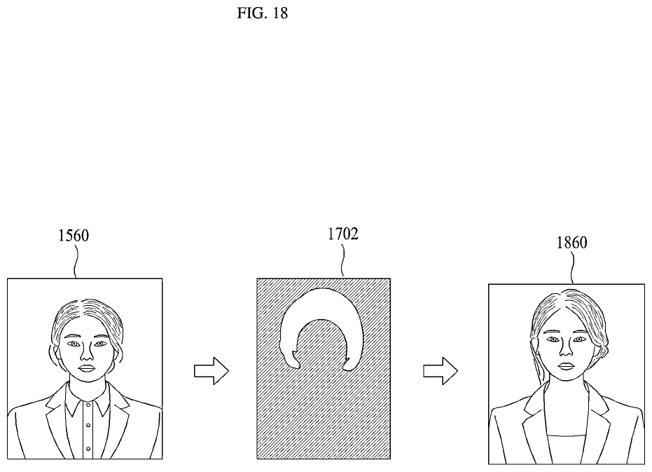

In inpainting masking, the masking range needs to include a potential hair position. Referring to FIG. 17, the processor 220 may extract a hair part 1701 using a parsing result of the body image 520 and then may create a mask 1702 for hair modulation based on the hair part 1701. Here, the processor 220 creates the hair mask 1702 with an area larger than the actual hair part 1701 within the range that does not damage individual identity of the face, such as eyes, nose, lips, ears, and eyebrows. Since inpainting in an artificial intelligence-based generative model, which is a process of filling in or reconstructing missing parts of an image, creates hair within a masked area, it is possible to use the hair mask 1702 in which an area is expanded toward a background outside the face without invading a wider area than the actual hair part 1701, that is, the face part for various styles. Referring to FIG. 18, the processor 220 may perform inpainting with the hair mask 1702 for a hairstyle change in the random photo 1560 created through img2img ControlNet. Here, the processor 220 may create a photo 1860 of a new hairstyle.

Meanwhile, if the face image 410 has a long hairstyle that goes beyond the shoulder line, hair cut along the shoulder line of the face image 410 is composited in an unnatural shape in the process of compositing the face image 410 into the body image 520. Therefore, when creating an image, the corresponding part may be regarded as a top collar rather than hair. To resolve this problem, as described above, a method of removing hair only up to ears using the parts analysis result 611 by the LIP model and the parts analysis part 612 by the PASCAL model for the face image 410 and labels for hair, face, and head may be used. This method may create a short hairstyle or a tied hairstyle, but has limitation in creating a long hairstyle.

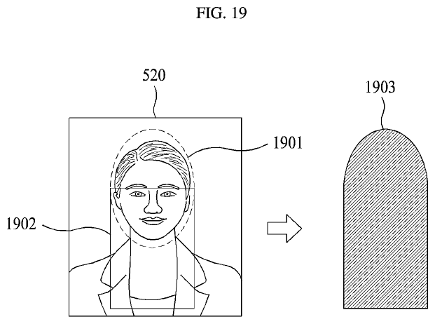

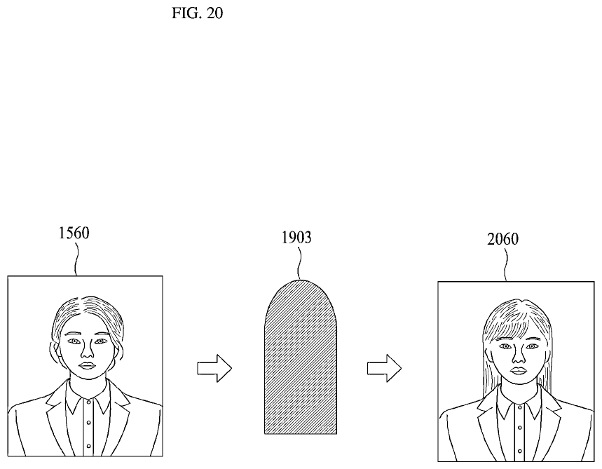

To improve this, example embodiments apply a method of synthetically creating a long hairstyle. Referring to FIG. 19, for the long hairstyle, the processor 220 may create a fake hairstyle shape 1903 by compositing a head part 1901 of the body image 520 and a square 1902 with an area exceeding the shoulder line based on the head part 1901. By processing and compositing the fake hairstyle shape 1903 into a desired shape, the long hair may be formed at lower cost without inpainting and a better masking area may be acquired even during inpainting. That is, in the process of acquiring the merged image 1030, the original face of the face image 410 may be pasted into the body image 520 combined with the fake hairstyle shape 1903. Here, the edge image 1240 for the merged image 1030 with the long hairstyle may be created and may be used as input to img2img ControlNet. Depending on example embodiment, as shown in FIG. 20, inpainting may be performed on the random photo 1560 created through img2img ControlNet with a hair mask corresponding to the long hairstyle shape 1903 for hairstyle change. Here, a photo 2060 of a natural long hairstyle may be created.

According to example embodiments, it is possible to create a portrait photo with personal identity with quality that meets requirements according to an ID photo standard using a single frontal face photo.

In some example embodiments, after creating the portrait photo, the computer device 200 may instruct an image forming device, such as a printer or other output device, to produce a high-resolution physical copy of the final image for use in a physical identification card or other official document. In some example embodiments, the computer device 200 may upload the final image to an online system, such as a government database, cloud storage, or secure server. In some example embodiments, the computer device 200 may compress, watermark, or encrypt the final image to ensure it meets specific security standards before uploading it to the online system.

The apparatuses described above may be implemented using hardware components, software components, and/or combination of the hardware components and the software components. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, a computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to some example embodiments may be configured in a form of program instructions performed through various computer methods and recorded in non-transitory computer-readable media. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Example embodiments transform the processor 220 into a special purpose processor that improves the functioning of the computer device 200 by leveraging AI models to transform a casual photo of the subject into a high-quality ID-compliant image that meets formal requirements with minimal user intervention. The processor 220 processes the photo, adjusting for lighting, background, facial alignment, and/or expression, ensuring that the final portrait conforms to strict ID standards, including head size, positioning, and background color. What previously required extensive manual editing and meticulous adherence to guidelines is now automated and provides improved accuracy. This improvement not only saves significant time and resources but also reduces errors, so that that each portrait is ready for official use without the need for resubmissions or corrections. This solution is a leap forward in ID image processing, quickly providing both reliability and ease in producing compliant, professional-quality ID photos of a subject from virtually any original photograph of the subject.

While this disclosure includes some example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. An image creation method implemented on a computer device including at least one processor, the image creation method comprising:
merging, by the at least one processor, a face area of a subject within a source image with a body target image to generate a merged image; and
providing, by the at least one processor, the merged image and an edge image of the merged image as input to an artificial intelligence model for image creation.

2. The image creation method of claim 1, wherein
the source image is a frontal face photo of the subject to be composited, and
the body target image is a frontal photo of an upper body that meets an identification (ID) photo standard.

3. The image creation method of claim 1, further comprising:
changing, by the at least one processor, a background color of the body target image, before the merging of the face area with the body target image.

4. The image creation method of claim 1, further comprising:
removing, by the at least one processor, a hair part below ears of the subject in the source image based on a parsing result of the source image, before the merging of the face area with the body target image.

5. The image creation method of claim 1, wherein the merging comprises:
rotating the source image in consideration of a face direction of the subject through face align; and
aligning and merging the face area of the subject in the source image with a face area of the body target image.

6. The image creation method of claim 1, wherein the merging comprises:
determining a size of the face area aligned in the body target image by determining a scale factor for the face area using at least one of a face width and a face height of the body target image.

7. The image creation method of claim 6, further comprising:
determining, by the at least one processor, the scale factor for the face area using both the face width and the face height of the body target image, wherein a greater weight is assigned to the face height than the face width.

8. The image creation method of claim 1, wherein the merging comprises:
determining a size of the face area aligned in the body target image using an intermediate value between a face width and a face height of the body target image and a ratio between the face width and a shoulder width of the body target image.

9. The image creation method of claim 1, wherein the merging comprises:
determining a position of the face area aligned in the body target image based on a chin position of the body target image.

10. The image creation method of claim 1, wherein the merging comprises:
determining a position of the face area aligned in the body target image based on a neck length determined based on a distance between a chin position of the body target image and a line connecting both shoulders.

11. The image creation method of claim 1, wherein the merging comprises:
creating the edge image through edge detection for the merged image; and
removing an edge of a neck part based on a jawline in the edge image.

12. The image creation method of claim 1, wherein the merging comprises:
creating the edge image through edge detection for the merged image;
extracting a jawline from the face area based on a parsing result of the face area; and
adding the jawline extracted from the face area to the edge image.

13. The image creation method of claim 1, wherein the merging comprises:
creating the edge image through edge detection for the merged image while preserving an original ear shape of the face area by adjusting a threshold for the edge detection and a control weight for a degree of freedom of image creation.

14. The image creation method of claim 1, wherein the providing comprises:
separating the edge image into a face edge image that includes an edge of a face part and a non-face edge image that includes a remaining edge excluding the face part.

15. The image creation method of claim 14, further comprising:
creating, by the at least one processor, a portrait photo using the merged image and the edge image through the artificial intelligence model,
wherein a control weight for limiting a degree of freedom of image creation is set to the face edge image.

16. The image creation method of claim 1, further comprising:
creating, by the at least one processor, a portrait photo using the merged image and the edge image through the artificial intelligence model; and
modulating a hairstyle of the portrait photo using a hair mask.

17. The image creation method of claim 16, wherein the modulating comprises:
modulating the hairstyle of the portrait photo using the hair mask with an area expanded toward an outer background of face of the body target image as a mask with an area larger than a hair part of the body target image.

18. The image creation method of claim 16, wherein the modulating comprises:
modulating the hairstyle of the portrait photo using a fake hairstyle shape that is a composite of a head part of the body target image and a shape with a set area based on the head part.

19. A non-transitory computer-readable recording medium storing instructions that, when executed by a processor, cause the processor to perform the image creation method of claim 1 on the computer device.

20. A computer device comprising:
at least one processor configured to execute computer-readable instructions on the computer device to cause the computer device to,
merge a face area of a subject within a source image with a body target image to generate a merged image, and
provide the merged image and an edge image of the merged image as input to an artificial intelligence model for image creation.
